(19) United States
(12) Patent Application Publication
(10) Pub. No.: US 2019/0180201 A1
(43) Pub. Date: Jun. 13, 2019

(54) METHOD, SYSTEM, AND DEVICE FOR ON-DEMAND DRIVING SERVICE

(71) Applicant: Andrew Quentin Legault, Vancouver (CA)

(72) Inventor: Andrew Quentin Legault, Vancouver (CA)

(21) Appl. No.: 16/217,033

(22) Filed: Dec. 11, 2018

Related U.S. Application Data
(60) Provisional application No. 62/597,365, filed on Dec. 11, 2017.

(51) Int. Cl. G06Q 10/02; G06Q 50/30; G08G 1/00; G06F 16/29

(52) U.S. Cl. CPC G06Q 10/02; G06F 16/29; G08G 1/20; G06Q 50/30

(57) ABSTRACT

A method and system for providing on-demand driving service over a computerized network. The system includes a management application, a user application, a primary driver application, and a chase driver application (paired driver accounts, primary and chase). The management application manages provision of on-demand driver services. The user application includes a graphical user interface that provides a plurality of selection categories needed to form a booking request. Forms associated with the selection categories are conditionally hidden together on the same user interface page. The primary driver application includes a location tracking device. The chase driver application tracks the primary driver, thereby permitting the second driver application to chase the first driver application while providing an on-demand driving service wherein a first driver drives a user vehicle and a second driver operates as a chase driver to pick-up the first driver on termination of the on-demand driving service.

### CROSS-REFERENCE TO RELATED APPLICATIONS

This invention claims priority, under 35 U.S.C. § 120, to the U.S. Provisional Patent Application No. 62/597,365 by Legault filed on Dec. 11, 2017, which is incorporated by reference herein in its entirety.

### BACKGROUND OF THE INVENTION

### Field of the Invention

The present invention relates to on-demand service systems, methods and devices, specifically to on-demand driving service system, methods, and devices.

### Description of the Related Art

Various systems, methods, and devices have been devised to facilitate the need to transport others from place to place. These include bussing, train, plane, and other mass transit systems as well as people movers like escalators, elevators, and moving sidewalks. Others have been developed to provide a more on-demand type of travel for individuals and small groups. These include taxis, shuttles, horse-and-buggy, bicycle-and-buggy, and the like. Also, people will sometimes contact friends and family to “give them a ride” from one place to another.

In such a situation, it is common for friends to go out for drinks and to select one member of the party to be a “designated driver.” That designated driver has the responsibility to not become inebriated and to drive the others home at the end of the night. This allows the others to imbibe freely with the knowledge that a sober driver will be getting them home. This also removes the risk of legal consequences for driving while intoxicated. While this system may not be applicable in all situations where people may be drinking or taking drugs and then need to drive somewhere, it is better than nothing in the situations where it does apply.

There are also driving services, similar to taxi services, that individuals may turn to if they finds themselves in need of a ride, inebriated or not, that are on demand services, including but not limited to those provided under the brands Uber and Lyft. These services provide downloadable applications that provide a user interface tied to user accounts so that individuals and businesses can “order” a transport over the user interface.

Examples of references related to the present invention are described below in their own words, and the supporting teachings of each reference are incorporated by reference herein:

U.S. Patent Application Publication No. 20080014908 by Vasant, discloses a system and method are disclosed for coordinating customized mobility services through a network. The system includes a network, an access device configured to connect to the network, a server configured to communicate with the access device through the network, an identification module configured to identify a user's customer account and to associate at least one mobility service with the user's customer account, and a virtual mobile attendant configured to coordinate customized mobility services through the network. The method includes receiving personal vehicles supply information from at least one transit management system, receiving demand information from a virtual mobility attendant, determining target information from the supply information and the demand information for the personal vehicles in a vicinity most closely matching the end user demand information, and transmitting the target information to the virtual mobility attendant.

U.S. Patent Application Publication No. 20140172727 by Abhyanker et al., discloses a method, device, and system of a short-term automobile renting system and method are disclosed. In one embodiment, a method of a dispatch server includes associating a user with a ride request system and determining that the user has requested to be picked-up at a geo-spatial location associated with a pick-up address of the user. The geo-spatial location is determined based on any of a current geo-spatial location of a mobile device through which the user requests the pick-up and/or a manually entered address in the mobile device of the user that is communicatively coupled with the dispatch server in this aspect. A private vehicle is automatically dispatched in the geo-spatial vicinity of the geo-spatial location associated with the pick-up address of the user using a processor and a memory.

U.S. Patent Application Publication No. 20140304646 by Rossmann, discloses a sliding side menu GUI interface for computerized devices that shows indicia of updated content on at least some of its various menu items. These indicia can include icons representing graphics or thumbnail images representing individuals that caused the updated content, type of updated content, amount of updated content, or other useful information. This enables the user, while operating an original application screen, while still retaining the original screen in short term human memory, to quickly call up the sliding side menu, look for indicia of updated content or interesting new content, and if there is no such content return to the original screen without significant human short term memory loss of the original screen. The method may be implemented by server software, device software, or combination of server and device software. The method is well suited for small touchscreen devices such as smartphones and tablets.

U.S. Patent Application Publication No.: 20150227999 by Maguire et al., discloses crowd-sourced computer-implemented methods and systems of collecting requested data. One embodiment of the invention may be implemented as an electronic device including a request creating unit, a transmitter, and a receiver. The request creating unit is configured to create a request. The transmitter is configured to transmit the request for data to a plurality of collecting devices, to transmit an acceptance message to at least one of the plurality of collecting devices, and to transmit payment to each of the plurality of collecting devices to which the acceptance message was sent. The receiver is configured to receive bids from each of the plurality of collecting devices as proposed payment for collecting the data, and to receive the data from each of the plurality of collecting devices.

U.S. Patent Application Publication No. 20160225051 by Amin et al., discloses a method for requesting an on-demand service on a computing device is provided. One or more processors determine the current location of the computing device. A multistate selection feature of a plurality of service options for providing the on-demand service is presented on the display of the computing device. The multistate selection feature enables a user to select a service option that is available within a region that includes the current location to provide the on-demand service. In response to the user selecting one of the plurality of service options, a summary user interface is presented on the display to provide region-specific information about the on-demand service based on the selected service option.

The inventions heretofore known suffer from a number of disadvantages, including but not limited to one or more of: being difficult to use, failing to account for inebriated users, being difficult for inebriated users to use, being complicated, requiring knowledge of a hierarchical menu architecture, requiring the use of multiple buttons on a computing device, failing to show all options at all times, hiding menu choices, not providing vehicle pick-up with a driving service, being slow to operate, being slow to use, failing to reduce user error, failing to reduce system error, not being safe, being inconvenient, and requiring users to take actions later.

What is needed is a method, system, and/or device that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available systems and methods. Accordingly, the present invention has been developed to provide a system or method of providing an on-demand driving service.

In one non-limiting embodiment, there is a system for providing on-demand driving service over a computerized network. The system may include a management application, a user application, a primary driver application, and a chase driver application. The management application may be in communication with a computerized network and/or may manages provision of on-demand driver services. The user application may be resident on a user computing device that may be in communication with the management application over the computerized network and/or may include a graphical user interface that may provide a plurality of selection categories that may be associated with provision of on-demand driving service. It may be that forms associated with one, more, or each of the plurality of selection categories may be conditionally hidden together on the same user interface page. The primary driver application may be resident on a primary driver computing device and/or may be in communication with the management application over the computerized network. The primary driver application may include a location tracking device that may track a location of the primary driver computing device. The chase driver application may be resident on a chase driver computing device that may be in communication with the first driver application. The chase driver application may include a graphical user interface that may display the tracked location of the primary driver computing device, thereby permitting the second driver application to chase the first driver application while providing an on-demand driving service wherein a first driver drives a user vehicle and a second driver operates as a chase driver to pick-up the first driver on termination of the on-demand driving service.

It may be that the plurality of selection categories includes at least two of the selection categories consisting of: payment method/terms, notes/instructions, and price estimate. It may be that the plurality of selection categories are conditionally hidden by toggle selection of an icon displayed via the graphical user interface of the user application. It may be that the primary driver application and the chase driver application are functionally linked through the management application to form a single drive crew account within the management application. It may be that the management application submits a booking request from the user application to one of: the primary driver application and the chase driver application. It may be that the user application includes all selection categories required for submission of a booking request for on-demand driving service requirements on the same user interface page and every form associated with each of the plurality of selection categories is conditionally hidden together on the same user interface page. It may be that the user application submits a driver query to the management application to query a driver database including nearby drivers that have sign-in to the system. It may be that the user application provides the user the ability to select a driver queried from the management application and then includes the selected driver in the booking request. It may be that the primary driver application displays the booking request and provides the primary driver the ability to accept or decline the booking request.

In another non-limiting embodiment, there is a method of providing an on-demand driving service over a computerized network. The method may include one or more of the steps of: providing paired driver accounts, providing a user application in association with a user account, functionally coupling the paired driver accounts with the user account, tracking, and/or closing a transport transaction. The step of providing paired driver accounts may happen within a management application in communication with a computerized network that manages provision of on-demand driver services. The step of providing a user application may be in association with a user account and it may be that the user application is communication with the management application over the computerized network and/or includes a graphical user interface that may provide one, more, or all selection categories required for submission of a booking request for on-demand driving service requirements on the same user interface page and it may be that one, more, or every form associated with each of the plurality of selection categories is conditionally hidden together on the same user interface page. The step of functionally coupling the paired driver accounts with the user account may be via a booking request for on-demand driving services. The step of tracking the physical locations may be via a tracking device and/or may be of a computing device that may be associated with the paired driver accounts or the user account.

It may be that the management application submits a booking request from the user application to the paired driving accounts. It may be that the user application submits a driver query to the management application to query a driver database including nearby drivers that have sign-in to the system. It may be that the user application provides the user the ability to select a driver queried from the management application and then includes the selected driver in the booking request. It may be that the primary driver application displays the booking request and provides a primary driver of the paired driving account the ability to accept or decline the booking request.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 illustrates a system of providing on-demand driving services over a computerized network, according to one embodiment of the invention;

FIG. 2 is a module diagram of a management application of a system of providing on-demand driving services over a computerized network, according to one embodiment of the invention;

FIG. 3 is a module diagram of a user interface application of a system of providing on-demand driving services over a computerized network, according to one embodiment of the invention;

FIG. 4 is a module diagram of a driver application of a system of providing on-demand driving services over a computerized network, according to one embodiment of the invention;

FIG. 5 illustrates operation of a system of providing on-demand driving services over a computerized network, according to one embodiment of the invention;

FIG. 6 shows exemplary screenshots of a foldout user interface in operation, according to one embodiment of the invention;

FIG. 7 is a flow chart of a method of providing an on-demand driving service over a computerized network;

FIG. 8 is a prophetic screenshot of a user interface of an on-demand driving service, according to one embodiment of the invention;

FIG. 9 is a prophetic screenshot of a user interface of an on-demand driving service, according to one embodiment of the invention; and

FIGS. 10 and 11 together form a data flow diagram of a system for providing on-demand driving service, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

Many of the functional units described in this specification have been labeled as modules in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. Modules may also be implemented in software for execution by various types of processors. An identified module of programmable or executable code may, for instance, comprise one or more physical or logical blocks of computer instructions which may, for instance, be organized as an object, procedure, or function.

Nevertheless, the executables of an identified module need not be physically located together, but may comprise disparate instructions stored in different locations which, when joined logically together, comprise the module and achieve the stated purpose for the module. Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The various system components and/or modules discussed herein may include one or more of the following: a host server, motherboard, network, chipset or other computing system including a processor for processing digital data, a memory device coupled to a processor for storing digital data; an input digitizer coupled to a processor for inputting digital data; an application program stored in a memory device and accessible by a processor for directing processing of digital data by the processor, a display device coupled to a processor and/or a memory device for displaying information derived from digital data processed by the processor; and a plurality of databases including memory device(s) and/or hardware/software driven logical data storage structure(s).

Various databases/memory devices described herein may include records associated with one or more functions, purposes, intended beneficiaries, benefits and the like of one or more modules as described herein or as one of ordinary skill in the art would recognize as appropriate and/or like data useful in the operation of the present invention.

As those skilled in the art will appreciate, any computers discussed herein may include an operating system, such as but not limited to: Android, iOS, BSD, IBM z/OS, Windows Phone, Windows CE, Palm OS, Windows Vista, NT, 95/98/2000, OS X, OS2; QNX, UNIX; GNU/Linux; Solaris; MacOS; and etc., as well as various conventional support software and drivers typically associated with computers. The computers may be in a home, industrial or business environment with access to a network. In an exemplary embodiment, access is through the Internet through a commercially-available web-browser software package, including but not limited to Internet Explorer, Google Chrome, Firefox, Opera, and Safari.

The present invention may be described herein in terms of functional block components, functions, options, screen shots, user interactions, optional selections, various processing steps, features, user interfaces, and the like. Each of such described herein may be one or more modules in exemplary embodiments of the invention even if not expressly named herein as being a module. It should be appreciated that such functional blocks and etc. may be realized by any number of hardware and/or software components configured to perform the specified functions. For example, the present invention may employ various integrated circuit components, e.g., memory elements, processing elements, logic elements, scripts, look-up tables, and the like, which may carry out a variety of functions under the control of one or more microprocessors or other control devices. Similarly, the software elements of the present invention may be implemented with any programming or scripting language such as but not limited to Eiffel, Haskell, C, C++, Java, Python, COBOL, Ruby, assembler, Groovy, PERL, Ada, Visual Basic, SQL Stored Procedures, AJAX, Bean Shell, and extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention may detect or prevent security issues with a client-side scripting language, such as JavaScript, VBScript or the like.

Additionally, many of the functional units and/or modules herein are described as being “in communication” with other functional units, third party devices/systems and/or modules. Being “in communication” refers to any manner and/or way in which functional units and/or modules, such as, but not limited to, computers, networks, mobile devices, program blocks, chips, scripts, drivers, instruction sets, databases and other types of hardware and/or software, may be in communication with each other. Some non-limiting examples include communicating, sending, and/or receiving data and metadata via: a wired network, a wireless network, shared access databases, circuitry, phone lines, internet backbones, transponders, network cards, busses, satellite signals, electric signals, electrical and magnetic fields and/or pulses, and/or so forth.

As used herein, the term “network” includes any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using other protocols, including but not limited to IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

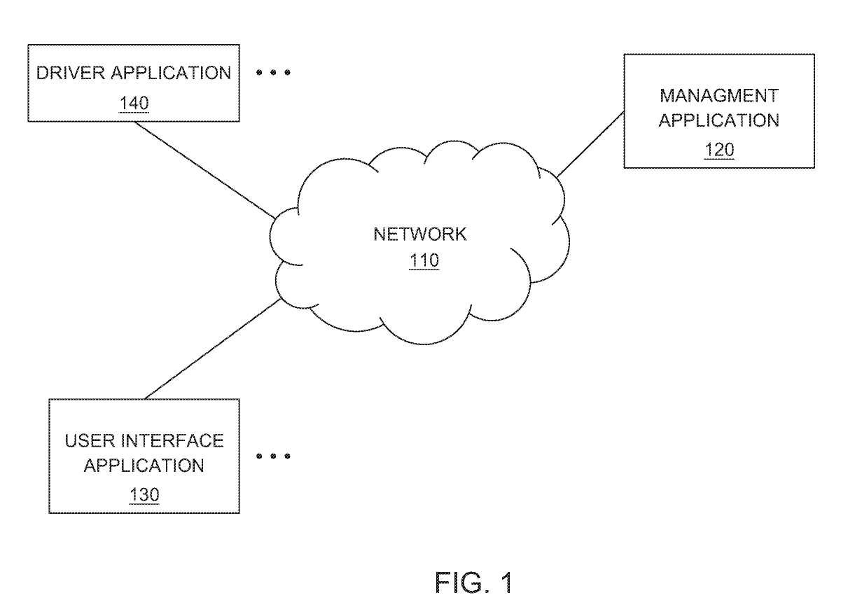

FIG. 1 illustrates a system of providing on-demand driving services over a computerized network, according to one embodiment of the invention. There is shown a management application 120, a plurality of driver applications 140, and a plurality of user interface applications (user applications) 130 each in communication with each other over a computerized network 110.

The illustrated management application 120 provides overall management, troubleshooting, tracking, control, and record keeping for the system, as well as providing information to other modules described herein in support of their functions. Accordingly, a multiplicity of drivers and users may be coordinated to provide an on-demand driving service over a computerized network 110 over a large area, including but not limited to a nationwide or larger service area. The management application 120 generally resides on a collection of servers having a commercially reasonable connection to the network 110 such that information may flow to and from the management application 120 over the network 110. The management application 120 may be distributed over a plurality of server farms located in different regions such that response times are very quick.

The illustrated driver applications 140 are distributed over computing devices of the various drivers associated with the system, generally on personal computing devices, such as but not limited to smartphones, tablets, laptops and the like having wireless connectivity to the network. Generally, there will be at least one driver application 140 instance per driver, though drivers may have more than one installed one more than one device. Generally, each driver will have a single account with the system that manages the relationship and operations of the driver with respect to the system (e.g. payments, pick-up drop-off instructions, rules, incentives). The driver applications/accounts may be paired so that pairs of drivers are provided instructions and etc. to allow them to act together when a pick-up is requested that includes a request to driver a user's vehicle to a destination. Paired driver accounts may share location information, instruction information, user information, incentive information, review information, and the like and may split payments, costs, and tips.

The illustrated user interface applications 130 are distributed over computing devices of the various users associated with the system, generally on personal computing devices, such as but not limited to smartphones, tablets, laptops and the like having wireless connectivity to the network. Generally, there will be at least one user interface application instance per user, though users may have more than one installed one more than one device. Generally, each user will have a single account with the system that manages the relationship and operations of the user with respect to the system (e.g. payments, pick-up drop-off instructions, rules, incentives). The user interface application 130 may include an operational interface that provides all the functions, features, and information needed to effect a pick-up and drop-off on a single page, with foldout form sections that may be selectably hidden and presented by operation of a graphical user interface to allow the user to see all options on a single page without having to refresh pages, load new pages, click “back” to go to a previous page, and the like. Accordingly, the user interface is uniquely simple to use, especially by those who may be inebriated and otherwise have a difficult time operating the user interface well enough to successfully order and effect a pickup.

The illustrated network 110 provides communication between and amongst the management application 120, the driver application(s) 140, and the user interface application(s) 130. The illustrated network 110 may include both wired and wireless communication capabilities and may allow for the various modules described herein to communicate with third party modules/devices, such as but not limited to GPS and mapping modules. The network 110 provides a bridge for information and communications to travel between modules described herein.

There may be one or more control modules within the system that manage, direct or otherwise control other modules/applications described herein. A control module may provide operational instructions and commands to the modules and components of the system. The control module(s) may be in communication with the modules and components of the system (and/or other modules described herein) and/or provide managerial instructions and commands thereto. The source of such instructions/commands may be from one or more other modules described herein and/or through interactions between one or more other modules described herein. The control module(s) may set parameters and settings for each module and component of the system. Non-limiting examples of a control module may be a control module described in U.S. Pat. No. 5,430,836, issued to Wolf et al.; or a control module described in U.S. Pat. No. 6,243,635, issued to Swan et al. which are incorporated for their supporting teachings herein. A control module may include but is not limited to a processor, a state machine, a script, a decision tree, and the like.

In operation, users and drivers download their respective applications 130, 140 onto one or more personal computing devices, generally portable devices, such as but not limited to smartphones, tablets, laptops and the like. The drivers and users, through their respective user interfaces or through other user interfaces (e.g. a specialized signup page over the network that links to the management application) creates an account within the system and stores therein information related to their identification, their vehicles and identification of the same, their preferences and user settings, their payment settings (for providing and/or receiving payment), and other information relevant to one or more modules herein or that one of ordinary skill in the art would recognize as being useful or relevant to one or more modules, functions, features, components, or the like described herein.

Once accounts have been setup, the drivers may activate their accounts over their driver applications 140, which notifies the management application 120 that they are available to provide service through the system. Activation may include pairing of two driver accounts to notify the system that the two drivers are operating together and available for designated driver and chase car service where the user's vehicle is driven by one driver and the chase car is operated by the other driver.

The users may operate their user interface applications 130 to request a pick-up and to provide other information relevant to the same (e.g. pick-up location, drop-off location, whether they need their vehicle to be driven). Where a user notifies the system that they need their vehicle to be driven, a notification of a service opportunity is sent to one or more paired driver accounts that are in the service area and those accounts are allowed the opportunity to accept or reject the opportunity. Alternatively, the user may be offered one or more sets of paired drivers from which to choose and once chosen the offer is provided to the same. Once accepted, information about the accepted service call is sent to the user interface application 130 for display to the user.

Once the driver pair arrives at the pick-up location, one driver exits the chase car and enters the user's vehicle, with permission of the user and in the company of the user and proceeds to drive the user to where they want to do. The chase car follows with the other driver in control thereof. The system tracks the location of the two driver applications (i.e. the devices on which they reside) and the user interface application device. Alerts may be sent to one or more devices if the locations of the same diverge unexpectedly (e.g. if the user drops their phone at the pickup location, the chase car loses the user's car).

On arrival at the drop-off location, the designated driver exits the user's vehicle and gives them the keys. The system closes the transport transaction and offers the parties thereto the ability to make notes, post reviews, apply tips, and the like with respect to the transaction.

In one non-limiting embodiment, there is a system, method, and/or device that provides designated driver pickup services on demand and manages the same, such that a second driver drives the user's car to their destination, following behind the pick-up vehicle with the user.

In one-non-limiting embodiment, there is a system, method, and/or device that provides designated driver pickup services on demand that includes a user interface wherein the operational page thereof is a single page with “fold-out” sections instead of separate pages or instances.

In one non-limiting embodiment, there is an application that offers both designated driving and ride-sharing within the same application (“app”). There is a function page that provides a single car for ride-sharing and a double car for designated driving (i.e. includes the service of picking up the user's car). Once they select, then the app books the ride for them. They create an account when they install the app. There is a booking page, a payment page, and, etc., but, instead of those pages cascading open and having to operate on a page by page basis, the pages just drop down, while leaving the other pages open. There is a button for them if they just want to go home, that will automatically select the things they need so they can go home. The pages are not separate pages that are their own instances. Instead the pages are folded portions of a single window/page that you can unfold/fold in order to access/hide them as you interact with the screen. This kind of interface reduces how complicated it is to interact with the system. It reduces clicks/keystrokes. Using this kind of interfaces eliminates the need to go “back.” They get notifications throughout the process of using the app. As part of an account, one registers their vehicle, including information about it, so the service can pick up the vehicle.

In one non-limiting embodiment, there is a system for providing on-demand driving service over a computerized network. The system may include a management application, a user application, a primary driver application, and a chase driver application. The management application may be in communication with a computerized network and/or may manages provision of on-demand driver services. The user application may be resident on a user computing device that may be in communication with the management application over the computerized network and/or may include a graphical user interface that may provide a plurality of selection categories that may be associated with provision of on-demand driving service. It may be that forms associated with one, more, or each of the plurality of selection categories may be conditionally hidden together on the same user interface page. The primary driver application may be resident on a primary driver computing device and/or may be in communication with the management application over the computerized network. The primary driver application may include a location tracking device that may track a location of the primary driver computing device. The chase driver application may be resident on a chase driver computing device that may be in communication with the first driver application. The chase driver application may include a graphical user interface that may display the tracked location of the primary driver computing device, thereby permitting the second driver application to chase the first driver application while providing an on-demand driving service wherein a first driver drives a user vehicle and a second driver operates as a chase driver to pick-up the first driver on termination of the on-demand driving service.

In operation of the illustrated embodiment, it may be that:
the plurality of selection categories includes at least two of the selection categories consisting of: payment method/terms, notes/instructions, and price estimate;
the plurality of selection categories are conditionally hidden by toggle selection of an icon displayed via the graphical user interface of the user application;
the primary driver application and the chase driver application are functionally linked through the management application to form a single drive crew account within the management application;
the management application submits a booking request from the user application to one of: the primary driver application and the chase driver application;
the user application includes all selection categories required for submission of a booking request for on-demand driving service requirements on the same user interface page and every form associated with each of the plurality of selection categories is conditionally hidden together on the same user interface page;
the user application submits a driver query to the management application to query a driver database including nearby drivers that have sign-in to the system;
the user application provides the user the ability to select a driver queried from the management application and then includes the selected driver in the booking request; and/or
the primary driver application displays the booking request and provides the primary driver the ability to accept or decline the booking request.

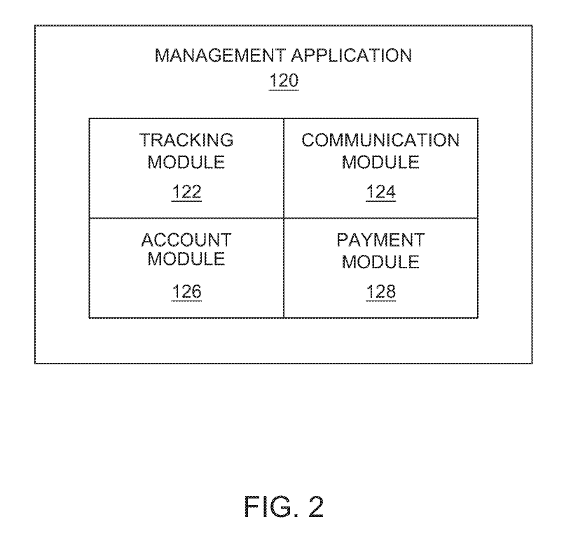

FIG. 2 is a module diagram of a management application 120 of a system of providing on-demand driving services over a computerized network (See FIG. 1), according to one embodiment of the invention. There is shown a management application 120 including a plurality of modules, illustrated modules including a tracking module 122, a communication module 124, an account module 126, and a payment module 128.

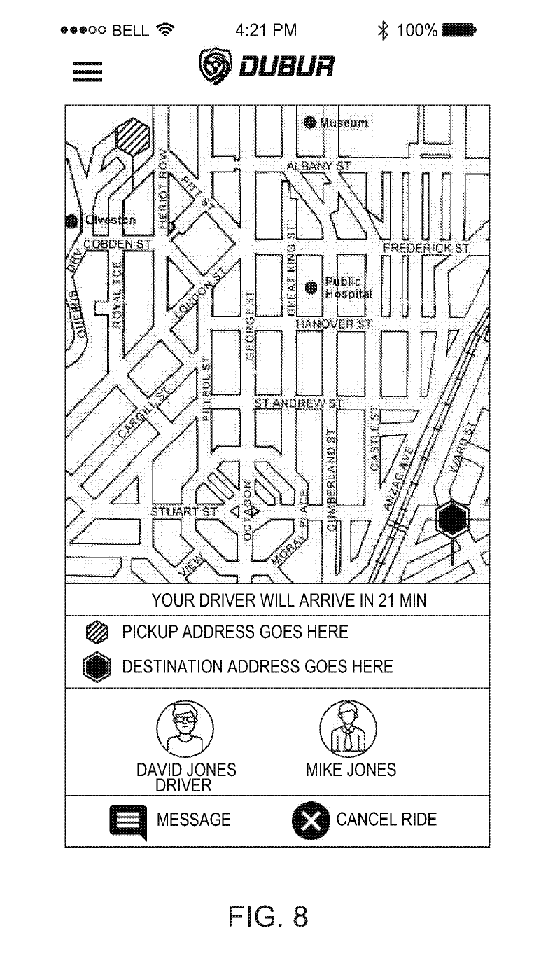

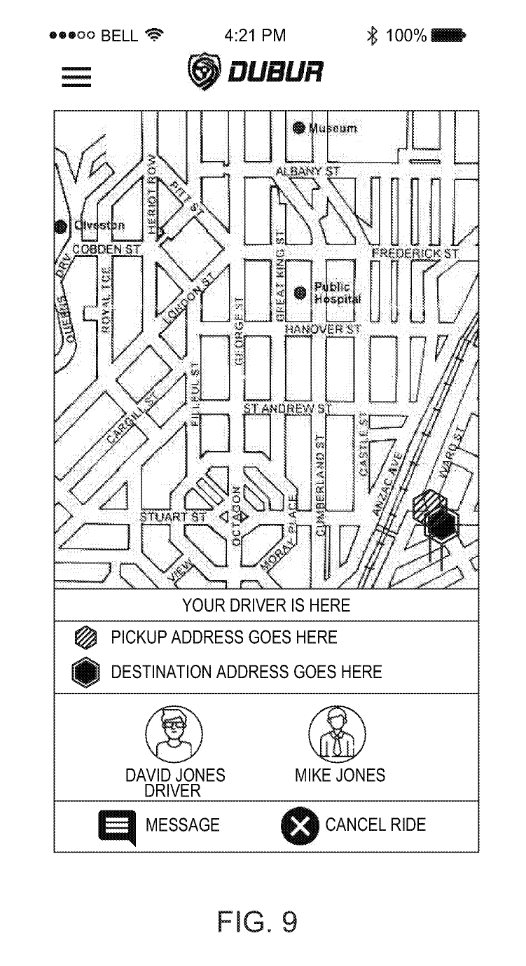

The illustrated tracking module 122 tracks riders and drivers (single drivers and paired drivers) and user's in real-time (see FIGS. 8 and 9), including tracking the chase car. The tracking module 122 may also calculate which drivers and/or driver pairs are within the service area for a particular user's pick-up request thereby matching drivers and users. It may do so by calculating distances and/or time's to pickup based on location information of various drivers with respect to the user. The tracking module 122 may be functionally coupled to one or more GPS modules, such as but not limited to GPS devices included with smartphones operated by the drivers and users. The tracking module may be functionally coupled to one or more mapping applications, such as but not limited to Google Maps by Google Inc., and Mapquest maps by Mapquest.

The illustrated communication module 124 provides communication via one or more communication devices such as but not limited to a network card, system bus, or wireless communication module, and communicates with a computerized network. The illustrated communication module 124 may provide/manage notifications to the users and drivers of the system and may manage booking requests. The communication module 124 provides communication capabilities, such as wireless communication, to the modules and components of the system and the components and other modules described herein. The communication module 124 provides communication between a wireless device, such as a mobile phone, and a computerized network and/or to facilitate communication between a mobile device and other modules described herein. The communication module 124 may have a component thereof that is resident on a user's mobile device. Non-limiting examples of a wireless communication module may be but not limited to: a communication module described in U.S. Pat. No. 5,307,463, issued to Hyatt et al.; or a communication module described in U.S. Pat. No. 6,133,886, issued to Fariello et al., which are incorporated for their supported herein.

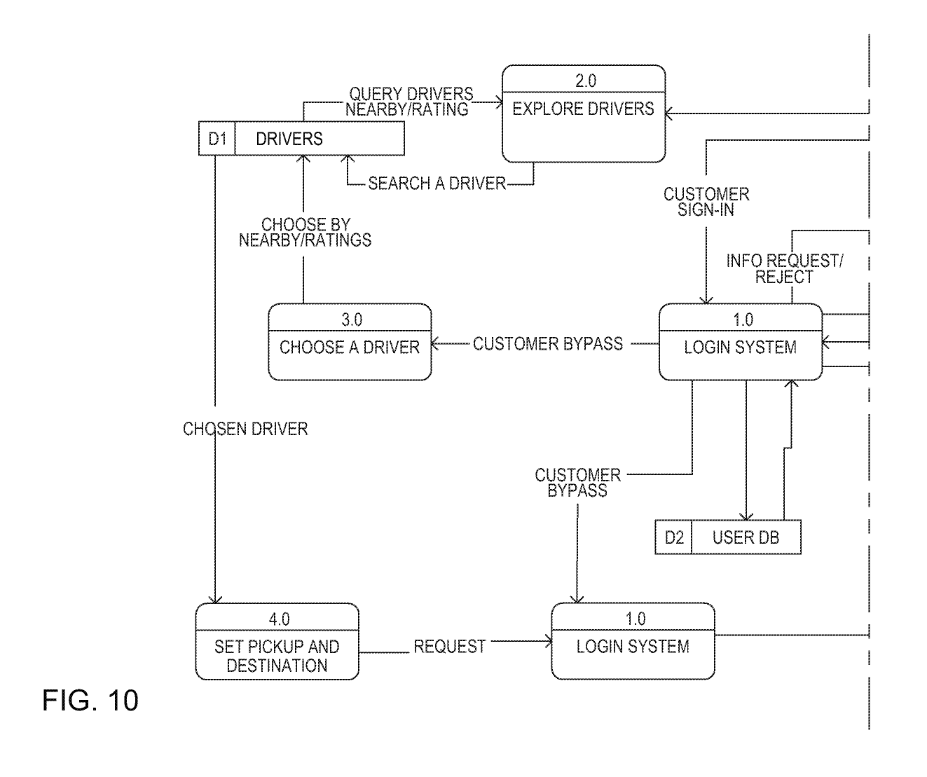

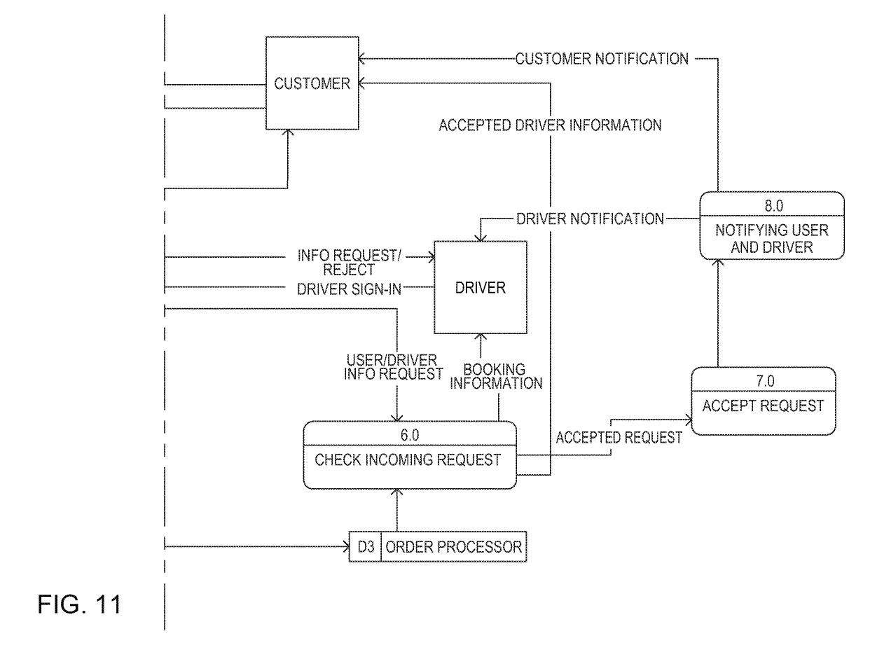

The illustrated account module 126 manages a multiplicity of accounts related to the system, including but not limited to driver accounts, user accounts, administrator accounts, IT accounts, auditor accounts, and the like and combinations thereof, including but not limited to the pairing of driver accounts. The account module 126 may manage login/sign-in for the users and drivers (See 1.0 Login System of FIGS. 10 and 11). The account module 126 may include one or more database applications that store records or other organizations of data that allow for information related to a particular account to be stored and access as needed (See the driver database D1 and the user database D2 of FIGS. 10 and 11). The account module 126 may include instructions for enforcing one or more preferences, settings, rules, limitations, and the like on one or more accounts included therein.

The illustrated payment module 128 manages, processes, executes, schedules, and/or otherwise handles payments within the system. The payment module 128 is in communication with each of the user interface modules and the driver modules such that it can receive authorization to charge payments and send payments as needed by the system and transactions. The payment module 128 may include P.O.S. systems, inventory/service systems, customer service systems, customer account tracking systems, buyer reward systems, and the like and combinations thereof. Such systems may provide real-time information about purchases and non-purchases or may update on particular occasions. The payment module 128 is configured to store purchasing data associated with the users and payment information with respect to drivers. Non-limiting examples of a payment module include a purchase module as described in U.S. Patent Publication No.: 2010/0179846, by Best et al.; or a purchase module as described in U.S. Patent Publication No.: 2010/0094726, by Tuli; wherein these examples are incorporated for their supported teachings herein.

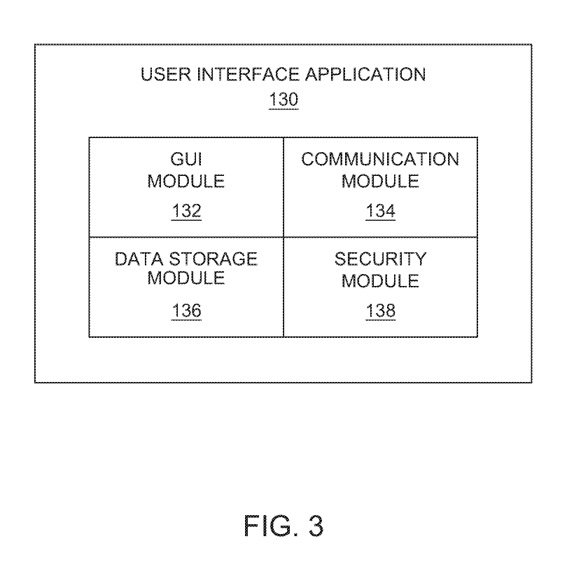

FIG. 3 is a module diagram of a user interface application (user application) 130 of a system of providing on-demand driving services over a computerized network (See FIG. 1), according to one embodiment of the invention. There is shown a user interface application 130 including a plurality of modules, illustrated modules including a GUI module 132, a communication module 134, a data storage module 136, and a security module 138.

The illustrated GUI (graphical user interface) module 132 provides an interface through which the user may interact with the system. The GUI 132 includes one or more pages of user interface screens and includes at least one page with form and/or other sections that are hideable/showable by action of the user via the GUI 132, such that all such forms/etc. may be displayed on a single interface page and “folded” in and out as desired by the user, without the user having to open new pages, click a “back” button, open other applications, or otherwise leave that page. Generally, the page with the user hideable/showable sections is the main operational page that allows the user to request a pick-up and drop-off. The GUI module 132 includes devices and programming sufficient to communicate with the network, to display operational information to the users and to receive input from the users. Generally, such may be in the form of a personal computer, dumb-terminal, gaming console, smartphone, tablet, or the like, but other embodiments are contemplated. Such will generally include a processor, a display device (e.g. monitor, tv, touchscreen), an audio device (e.g. speaker, microphone), memory, a bus, a user input device (e.g. controller, keyboard, mouse, touchscreen), and a communication device (e.g. a network card, wireless transponder), each in communication with one or more of the others as appropriate for the function thereof, generally over the bus. There may be a plurality and a variety of such graphical user interface modules 132 in communication with the system over the network, with some being for drivers and others being for users, administrators and the like and combinations thereof.

The following are non-limiting examples of how to program a user interface to hide/show content on demand and are provided herein for their supporting teachings: JavaScript can be used is to hide or display content based on user behavior. For example, a user may select an option when filling out an on-line form, and their selection might cause other related form fields to appear. In this lesson, you will use CSS and Javascript to show and hide a form.

In this example written as instructions to a programmer, the software hides a form, then add a link that if clicked, will display the form:

Open javascript.html in both your text editor and web browser. Go to a style sheet for a previously created div#form. Add the following property to the style sheet:

display: none;

Now refresh your page in your browser. What happened? If everything worked properly, your form should no longer be visible. This is one of several ways to hide content using CSS. To make the element visible again, you will change this property to:

display: block;

However, in this case we want to make the element visible only if the user specifically requests it. So, we'll have to change the style dynamically, using JavaScript, triggered by an onclick event.

First, add the element that you want the user to click:

<button onclick=“toggleForm( )” id=“formButton”>Show form</button>

Note that this button has an id attribute. That's so you can access it easily using JavaScript.

Now that you have a button that, when clicked, calls the toggleForm( ) function, you need to create a toggleForm( ) function. Here's that function—just add it to the existing script section in the head of your web page:

function toggleForm( ) {

// get the form
var myForm = document.getElementById(‘form’);
// get the current value of the form's display property
var displaySetting = myForm.style.display;
// also get the form button, so we can change what it says
var formButton = document.getElementById(‘formButton’);
// now toggle the form and the button text, depending on current state
if (displaySetting == ‘block’) {

// form is visible. hide it
myForm.style.display = ‘none’;
// change button text
formButton.innerHTML = ‘Show form’;

}
else {

// form is hidden. show it
myForm.style.display = ‘block’;
// change button text
formButton.innerHTML = ‘Hide form’;

}

}

In this new toggleForm( ) function, you are using JavaScript to retrieve the form element, get the current value of its display style, then checking it. If the display is currently set to “block”, the form is visible, so you change the display to “none”, which hides the form. If the form is already hidden, you change the display to “block” to make it visible again. While you're switching the form's display back and forth from “block” to “none”, you're also changing the text (innerHTML) on the form button, so that alternates between “Show form” and “Hide form”, depending on the current display state of the form.

As another non-limiting example, Chrome, Firefox and Edge all have selectable functions to hide/show elements within their developer tools. These may be used with conditional programming to allow for elements to be hidden/shown on a click event, or other similar user selectable event.

The illustrated communication module 134 provides communication via one or more communication devices such as but not limited to a network card, system bus, or wireless communication module, and communicates with a computerized network. The communication module 134 may receive and/or otherwise process notifications from the management application and present the same to the user via the GUI. The communication module 134 may submit booking requests to the management application and facilitate sign-in/login to the system. The communication module 134 may provide for direct communication between the user and the driver via their associated GUI and/or may initiate communication via phone, text, SMS, VOIP, or other protocols. The communication module 134 provides communication capabilities, such as wireless communication, to the modules and components of the system and the components and other modules described herein. The communication module 134 provides communication between a wireless device, such as a mobile phone, and a computerized network and/or to facilitate communication between a mobile device and other modules described herein. The communication module 134 may have a component thereof that is resident on a user's mobile device. Non-limiting examples of a wireless communication module may be but not limited to: a communication module described in U.S. Pat. No. 5,307,463, issued to Hyatt et al.; or a communication module described in U.S. Pat. No. 6,133,886, issued to Fariello et al., which are incorporated for their supported herein.

The illustrated data storage module 136 collects and store data for various other modules of the system/application. The data storage module 136 is in communication with the various modules and components of the system over a computerized network and stores data transferred there through. The data storage module 136 stores data transferred through each of the modules of the system, thereby updating the system with up to date data and real time data. The data storage module 136 securely stores user data along with data transferred through the system. Data storage modules 136 may be databases and/or data files and the memory storage device may be, but is not limited to, hard drives, flash memory, optical discs, RAM, ROM, and/or tapes. A non-limiting example of a data base is Filemaker Pro 11, manufactured by Filemaker Inc., 5261 Patrick Henry Dr., Santa Clara, Calif., 95054. Non-limiting examples of a data storage module may include: a HP Storage Works P2000 G3 Modular Smart Array System, manufactured by Hewlett-Packard Company, 3000 Hanover Street, Palo Alto, Calif., 94304, USA; or a Sony Pocket Bit USB Flash Drive, manufactured by Sony Corporation of America, 550 Madison Avenue, New York, N.Y., 10022.

The illustrated security module 138 provides security to the user and prevents others from utilizing the user interface to find out information about the user or to steal their vehicle. Such may include one or more gated screens/pages/operations that are gated by one or more security process, such as but not limited to entry of a PIN, password, swipe pattern, or the like or biometric information, such as scanning a fingerprint or face recognition. The security module 138 may gate one or more of the following: user settings, user information, request pick-up functionality, user preferences, user vehicle information, user address information, and the like and combinations thereof.

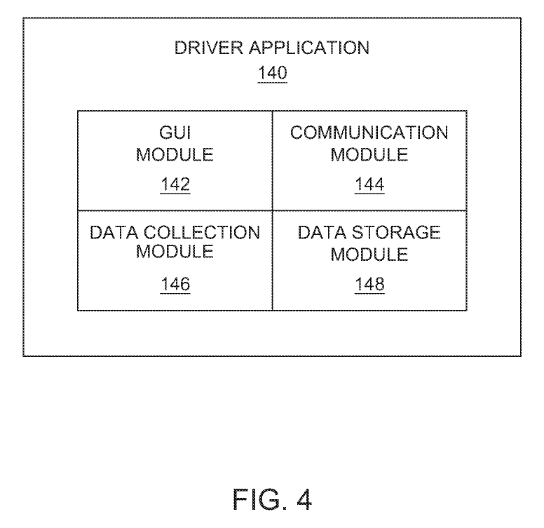

FIG. 4 is a module diagram of a driver application 140 of a system of providing on-demand driving services over a computerized network (See FIG. 1), according to one embodiment of the invention. There is shown a driver application 140, which may be a primary driver application or a chase driver application, including a plurality of modules, illustrated modules including a GUI module 142, a communication module 144, a data collection module 146, and a data storage module 148.

The illustrated GUI (graphical user interface) module 142 provides an interface through which the driver may interact with the system. The GUI 142 includes one or more pages of user interface screens and may also include one or more pages with form and/or other sections that are hideable/showable by action of the driver via the GUI, such that all such forms/etc. may be displayed on a single interface page and “folded” in and out as desired by the driver, without the driver having to open new pages, click a “back” button, open other applications, or otherwise leave that page. Generally, the page with the driver hideable/showable sections is the main operational page that allows the driver to coordinate a pick-up and drop-off. The GUI module includes devices and programming sufficient to communicate with the network, to display operational information to the users and to receive input from the users. Generally, such may be in the form of a personal computer, dumb-terminal, gaming console, smartphone, tablet, or the like, but other embodiments are contemplated. Such will generally include a processor, a display device (e.g. monitor, tv, touchscreen), an audio device (e.g. speaker, microphone), memory, a bus, a user input device (e.g. controller, keyboard, mouse, touchscreen), and a communication device (e.g. a network card, wireless transponder), each in communication with one or more of the others as appropriate for the function thereof, generally over the bus. There may be a plurality and a variety of such graphical user interface modules in communication with the system over the network, with some being for drivers and others being for users, administrators and the like and combinations thereof.

The illustrated communication module 144 provides communication via one or more communication devices such as but not limited to a network card, system bus, or wireless communication module, and communicates with a computerized network. The communication module 144 may receive and process notifications and booking requests from the management application and/or between the user and the driver and/or may initiate communication via phone, text, SMS, VOIP, or other protocols. The communication module may also facilitate sign-in to the system. The communication module 144 provides communication capabilities, such as wireless communication, to the modules and components of the system and the components and other modules described herein. The communication module 144 provides communication between a wireless device, such as a mobile phone, and a computerized network and/or to facilitate communication between a mobile device and other modules described herein. The communication module 144 may have a component thereof that is resident on a user's mobile device. Non-limiting examples of a wireless communication module may be but not limited to: a communication module described in U.S. Pat. No. 5,307,463, issued to Hyatt et al.; or a communication module described in U.S. Pat. No. 6,133,886, issued to Fariello et al., which are incorporated for their supported herein.

The illustrated data collection module 146 may include one or more sensors, such as but not limited to cameras, microphones, weight sensors, pressure sensors, and the like and combinations thereof that allow for the driver to collect data regarding transportation of the user and/or the user's vehicle so that one or more aspects of the service are documented. The data collection module 146 may include a location tracking device, such as but not limited to a GPS device, location triangulation device, tracking circuit, locator beacon, and the like and combinations thereof that may track the location of a device on which the driver application is resident, thereby permitting the system (e.g. a chase driver) to track a driver (e.g. the main driver). The data collection module 146 may include a data storage device that stores such information and may store it in relation to the service (e.g. stored along with a transaction number or other index number that allows it to be found later). Accordingly, the safe delivery of the user and their vehicle may be documented as appropriate.

The illustrated data storage module 148 collects and store data for various other modules of the system/application. The data storage module 148 is in communication with the various modules and components of the system over a computerized network and stores data transferred there through. The data storage module 148 stores data transferred through each of the modules of the system, thereby updating the system with up to date data and real time data. The data storage module 148 securely stores user data along with data transferred through the system. Data storage modules may be databases and/or data files and the memory storage device may be, but is not limited to, hard drives, flash memory, optical discs, RAM, ROM, and/or tapes. A non-limiting example of a data base is Filemaker Pro 11, manufactured by Filemaker Inc., 5261 Patrick Henry Dr., Santa Clara, Calif., 95054. Non-limiting examples of a data storage module may include: a HP Storage Works P2000 G3 Modular Smart Array System, manufactured by Hewlett-Packard Company, 3000 Hanover Street, Palo Alto, Calif., 94304, USA; or a Sony Pocket Bit USB Flash Drive, manufactured by Sony Corporation of America, 550 Madison Avenue, New York, N.Y., 10022.

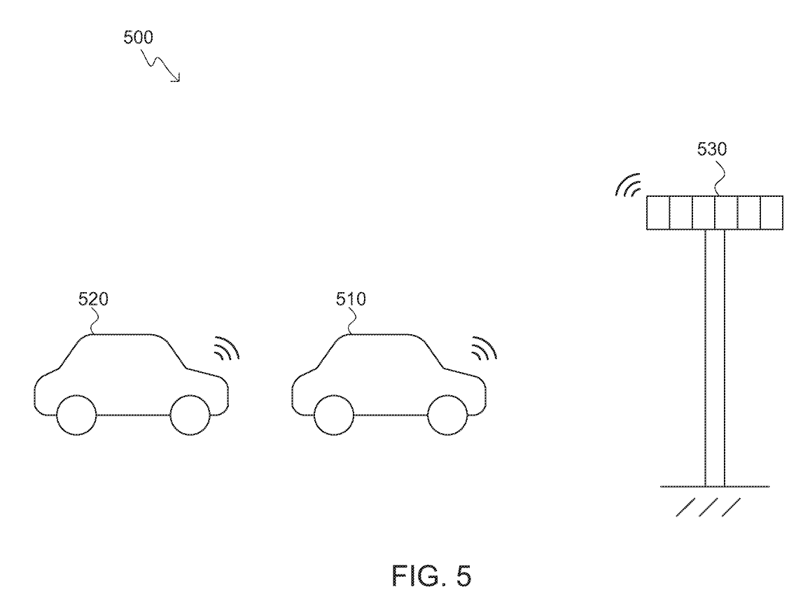

FIG. 5 illustrates operation of a system of providing on-demand driving services over a computerized network, according to one embodiment of the invention. There is shown a symbolic view of operation of a system 500 wherein there is a user's car 510 followed by a chase car 520, each in communication with one or more cellular network towers 530.

The user's car 510 contains one of the drivers, that driver's portable computing device with that driver's driver application active. It also contains the user, that user's portable computing device with that user's user interface application active thereon. The user's car and/or its contents are in wireless communication with the cellular network tower(s) 530 and thereby to the management application and to the other driver application in the chase car and to each other.

The chase car 520 contains the other of the drivers, that driver's portable computing device with that driver's driver application active. The chase car 520 and/or its contents are in wireless communication with the cellular network tower(s) 530 and thereby to the management application and to the other driver application in the user's car and to the user's device.

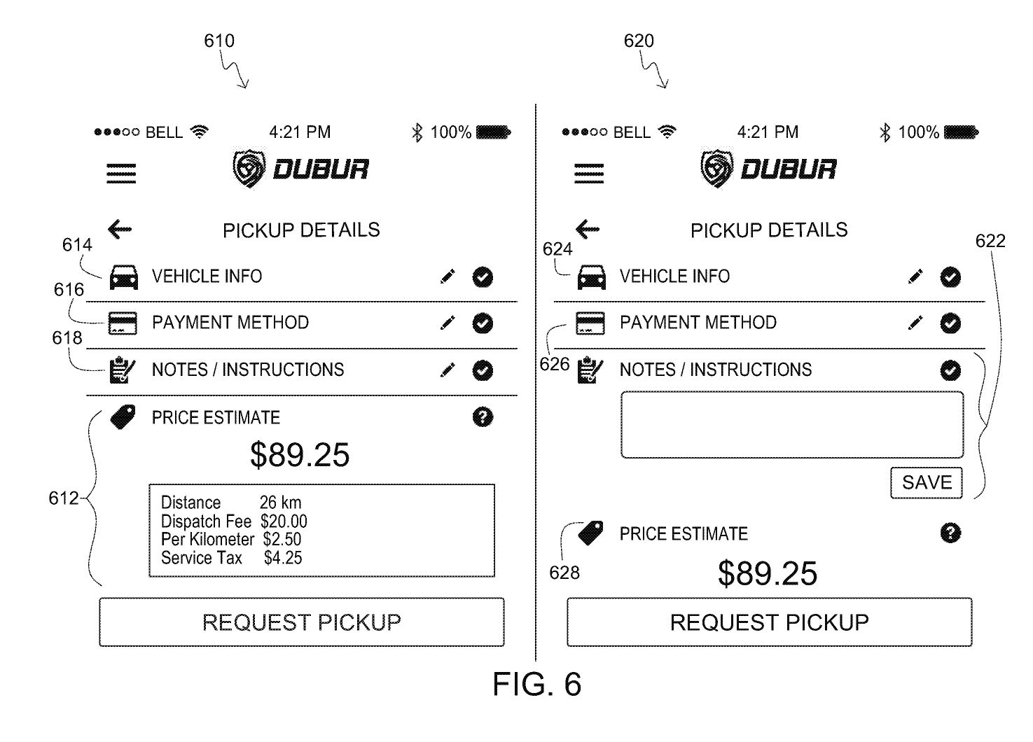

FIG. 6 shows exemplary screenshots of a foldout user interface in operation, according to one embodiment of the invention. There is shown a pair of side-by-side screenshots 610, 620 from a smartphone showing an operational page of a GUI of a user interface application, identified herein as a left screenshot 610 and a right screenshot 620.

The left screenshot 610 shows a page of a user interface application open whereby a user may request pickup service from the system. The user is able to manage vehicle info 614, payment method 616, notes and special instructions 618, and receive a price estimate 612 all from the same page because each of the selection categories 612, 614, 616, and 618 are presented using a folded view, wherein details are hidden unless the selection category is selected. In the left screenshot 610 the price estimate 612 category is selected and therefore folded-out to reveal its associated hidden content, while the vehicle info 614, payment method 616, and notes/instructions 618 selection categories are unselected and thereby folded-in whereby the associated content of each is hidden from view in the user interface.

The right screenshot 620 illustrates an open form on that page for the Notes/Instructions 622 selection category after the user has selected that portion to be opened/showed. The illustrated vehicle info 624, payment method 626, and price estimate 628 selection categories of the right screenshot 620 are folded-in, but may be opened/shown upon selection thereof by the user through the GUI of the user interface application. It may be that on selection of one selection category, one, more, or all other selection categories on that same page may fold-in thereby hiding their associated content.

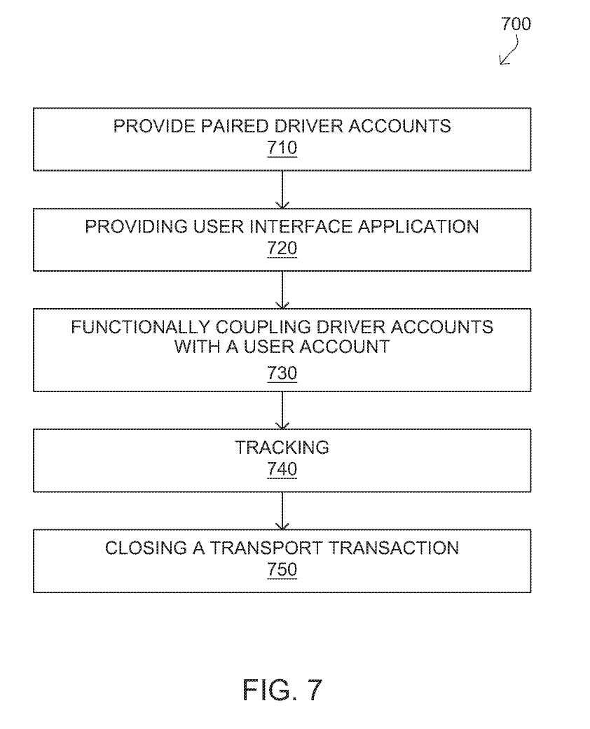

FIG. 7 is a flow chart of a method of providing an on-demand driving service over a computerized network. There is shown a method 700 having the steps of: providing paired driver accounts 710; providing user interface application(s) 720; functionally coupling driver accounts with a user account 730; tracking 740; and closing a transport transaction 750.

The illustrated step of providing paired driver accounts 710 may include one or more of the following: providing two or more driver accounts as described herein; pairing two or more driver accounts; making a record in a configuration setting that causes information addressed to one of the paired driver accounts to be copied to the other of the paired driver accounts; automatically generating a paired driver account that links to each of the two paired driver accounts but has its own driver identification information; providing a pairing button on a driver interface and/or a pairing wizard that allows two drivers to pair their accounts; providing a pair notification to a second driver after a first driver submits a pairing request; checking location information on receipt of a pairing request to determine if the paired drivers are proximate each other and automatically denying the pairing request of the location information does not substantially match to show that they are proximate each other. The step of providing paired driver accounts may happen within a management application in communication with a computerized network that manages provision of on-demand driver services.

The illustrated step of providing user interface application(s) 720 may include one or more of the following: providing an application for download by users to their portable electronic device(s); providing a user interface application having one or more of the features, functions, capabilities, and/or modules described herein. The step of providing a user application may be in association with a user account and it may be that the user application is communication with the management application over the computerized network and/or includes a graphical user interface that may provide one, more, or all selection categories required for submission of a booking request for on-demand driving service requirements on the same user interface page (may vary from system to system, but will include at least a pickup-location, a destination location, and identification information e.g. account id, name along with any information required by the system itself to qualify as a booking request within the system) and it may be that one, more, or every form associated with each of the plurality of selection categories is conditionally hidden together on the same user interface page.

The illustrated step of functionally coupling driver accounts with a user account 730 may include one or more of the following: matching a user pick-up request with one or more drivers and/or paired drivers; automatically generating a acceptance button on a GUI that allows for a driver and/or a user to accept a match; functionally linking a driver application with a user application such that information from one may be transmitted to the other for use thereby; and automatically generating a trip record and storing information related to the transport transaction therein. The step of functionally coupling the paired driver accounts with the user account may be via a booking request for on-demand driving services.

The illustrated step of tracking 740 may include one or more of the following: receiving and storing/analyzing/processing location information from one or more driver and/or user interfaces; storing the same in association with one or more driver and/or user accounts and/or trip records; and executing one or more software/hardware instructions contingent on relational locations of one or more drivers and/or users. The step of tracking the physical locations may be via a tracking device and/or may be of a computing device that may be associated with the paired driver accounts or the user account.

The illustrated step of closing a transport transaction 750 may include one or more of the following: processing a payment transaction; processing a tip transaction; recording trip information in association with one or more accounts/records within the system: storing media files; sending one or more notifications to one or more devices with trip information included therewith; and providing an electronic receipt.

In operation of the method, it may be that:
the management application submits a booking request from the user application to the paired driving accounts;
the user application submits a driver query to the management application to query a driver database including nearby drivers that have sign-in to the system;
the user application provides the user the ability to select a driver queried from the management application and then includes the selected driver in the booking request; and/or
the primary driver application displays the booking request and provides a primary driver of the paired driving account the ability to accept or decline the booking request.

FIGS. 8 and 9 are prophetic screenshots of a user interface of an on-demand driving service, according to one embodiment of the invention. There is shown a map in an upper portion of the screen with indicators (the illustrated hashed hexagon and the illustrated filled hexagon) showing locations of the pickup address and destination address on the map along with useful information related to the service and options for interoperation of the user therewith.

In the illustrated embodiment, FIG. 8 shows a screen before pickup including an onscreen message estimating the arrival time of the driver crew (driver and chase driver). The name of the driver along with an associated icon is presented alongside the name and icon of the user. As the chase driver will not generally interact with the user, a chase driver icon is not provided to the user in the illustrated example. There is a legend that informs the user as to the meaning of map indicators. A hamburger menu is shown on the top left of the screen which opens additional options to the user. The hamburger menu may open or provide access to foldout screen(s) such as but not limited to those shown in FIG. 6.

The illustrated FIG. 9 shows a screen with the service nearly completed as the pickup indicator has changed to indicate a combined location of the user's car and the chase car, with the pickup indicator near the destination address. The illustrated interfaces of FIGS. 8 and 9, or ones similar thereto, may be an interface provided to the driver of the chase car through that driver's driver application. The pickup indicator may track the location of the user's vehicle during the service and thereby may assist the chase car in tracking, following, or otherwise locating the user's car by the chase car driver, such as but not limited to if the two cars are separated by a traffic signal or intervening traffic.

FIGS. 10 and 11 together form a data flow diagram of a system for providing on-demand driving service, according to one embodiment of the invention. There is shown a Customer and a Driver that each interact with the various illustrated systems/modules (Login System, Explore Drivers, Choose a Driver, Set Pickup and Destination, Check Incoming Request, Accept Request, and Notifying User and Driver) and thereby with the driver database D1 and the user database D2 over a computerized network.

The illustrated Customer signs into the login system, which accesses the user database. From there the Customer may interact with a fold-out page where the Customer may make selections regarding the service options without having to navigate through a menu tree (e.g. See FIG. 6). The Customer may also choose a driver (by how close, i.e. nearby, and/or by ratings) pulling information from the driver database which may allow the Customer to explore for drivers to provide for selection to the Customer. On selection of a Driver, the Customer may set a pick-up and destination to create an order for the system to offer to the Driver. The Customer may also select a destination and parameters of the pickup and a Driver may be automatically selected by the system and associated with the booking order.

The Driver (and/or driver crew, of a driver and chase driver), to be found in the driver query has generally previously sign in to the system and is thereby available to receive info requests and to accept/reject orders for booking. Where the Driver accepts a booking request the system notifies the Driver and the Customer and initiates user interfaces on the associated applications to track the associated parties (e.g. See FIGS. 8 and 9) for the duration of the service to be provided.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, while the illustrated examples show only a single chase car with two drivers it may be that two drivers in two different cars are matched to a chase car request and at the end of the trip or end of the session of offering driving services the chase car returns the designated driver to their vehicle.

Further, while only particular sections are shown in FIG. 6, it may be that other or even all sections/portions described herein are on a single page. Such may include a “save” button that saves information on the entire page.

Also, there may be an overlay menu that autoscrolls to page section that is relevant instead of or together with hiding/showing sections, thereby also allowing users to do everything they need to on one page.

The system may facilitate and store images and other media files from drivers and/or users to allowing people to upload their pictures and/or pictures of their vehicles/homes. This may also allow the system to upload and store and associate with one or more accounts insurance and registration information.

The modules described herein may also have counterparts within other applications described herein. As a non-limiting example, there may be a data collection module of the user interface application that may record video/audio/images and share on the same on social media.

Incentives for users and drivers may include virtual currency that drivers and riders can earn and spend and that the management application tracks, awards, and redeems.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A system for providing on-demand driving service over a computerized network, comprising:
a. a management application, in communication with a computerized network, that manages provision of on-demand driver services;
b. a user application resident on a user computing device in communication with the management application over the computerized network and including a graphical user interface providing a plurality of selection categories associated with provision of on-demand driving service, wherein forms associated with each of the plurality of selection categories are conditionally hidden together on the same user interface page;
c. a primary driver application resident on a primary driver computing device in communication with the management application over the computerized network and including a location tracking device that tracks the location of the primary driver computing device; and
d. a chase driver application resident on a chase driver computing device, in communication with the first driver application, that includes a graphical user interface that displays the tracked location of the primary driver computing device, thereby permitting the second driver application to chase the first driver application while providing an on-demand driving service wherein a first driver drives a user vehicle and a second driver operates as a chase driver to pick-up the first driver on termination of the on-demand driving service.

2. The system of claim 1, wherein the plurality of selection categories include at least two of the selections categories consisting of: payment method/terms, notes/instructions, and price estimate.

3. The system of claim 1, wherein the plurality of selection categories are conditionally hidden by toggle selection of an icon displayed via the graphical user interface of the user application.

4. The system of claim 1, wherein the primary driver application and the chase driver application are functionally linked through the management application to form a single drive crew account within the management application.

5. The system of claim 1, wherein the management application submits a booking request from the user application to one of: the primary driver application and the chase driver application.

6. The system of claim 1, wherein the user application includes all selection categories required for submission of a booking request for on-demand driving service requirements on the same user interface page and every form associated with each of the plurality of selection categories is conditionally hidden together on the same user interface page.

7. A system for providing on-demand driving service over a computerized network, comprising:
a. a management application, in communication with a computerized network, that manages provision of on-demand driver services;
b. a user application resident on a user computing device in communication with the management application over the computerized network and including a graphical user interface providing all selection categories required for submission of a booking request for on-demand driving service requirements on the same user interface page and every form associated with each of the plurality of selection categories is conditionally hidden together on the same user interface page; and
c. a primary driver application resident on a primary driver computing device in communication with the management application over the computerized network and including a location tracking device that tracks the location of the primary driver computing device and provides the location of the primary driver computing device to the management application or the user application.

8. The system of claim 7, wherein the plurality of selection categories are each conditionally hidden by toggle selection of an icon displayed via the graphical user interface of the user application.

9. The system of claim 8, further comprising a chase driver application resident on a chase driver computing device in communication with the first driver application the includes a graphical user interface that displays the tracked location of the primary driver computing device, thereby permitting the second driver application to chase the first driver application while providing an on-demand driving service wherein a first driver drives a user vehicle and a second driver operates as a chase driver to pick-up the first driver on termination of the on-demand driving service.

10. The system of claim 9, wherein the management application submits a booking request from the user application to one of: the primary driver application and the chase driver application.

11. The system of claim 10, wherein the user application submits a driver query to the management application to query a driver database including nearby drivers that have sign-in to the system.

12. The system of claim 11, wherein the user application provides the user the ability to select a driver queried from the management application and then includes the selected driver in the booking request.

13. The system of claim 12, wherein the primary driver application displays the booking request and provides the primary driver the ability to accept or decline the booking request.

14. A method of providing an on-demand driving service over a computerized network, comprising the steps of:
a. providing paired driver accounts within a management application, in communication with a computerized network, that manages provision of on-demand driver services;
b. providing a user application in association with a user account, wherein the user application is communication with the management application over the computerized network and including a graphical user interface providing all selection categories required for submission of a booking request for on-demand driving service requirements on the same user interface page and every form associated with each of the plurality of selection categories is conditionally hidden together on the same user interface page;
c. functionally coupling the paired driver accounts with the user account via a booking request for on-demand driving services; and
d. tracking the physical locations, via a tracking device, of a computing device associated with the paired driver accounts or the user account.

15. The method of claim 14, further comprising the step of closing a transport transaction.

16. The method of claim 15, wherein the management application submits a booking request from the user application to the paired driving accounts.

17. The method of claim 16, wherein the user application submits a driver query to the management application to query a driver database including nearby drivers that have sign-in to the system.

18. The method of claim 17, wherein the user application provides the user the ability to select a driver queried from the management application and then includes the selected driver in the booking request.

19. The method of claim 18, wherein the primary driver application displays the booking request and provides a primary driver of the paired driving account the ability to accept or decline the booking request.

20. The method of claim 14, wherein the user application submits a driver query to the management application to query a driver database including nearby drivers that have sign-in to the system, the user application provides the user the ability to select a driver queried from the management application and then includes the selected driver in the booking request, and management application submits the booking request from the user application to the paired driving accounts.
